(19) United States
(12) Patent Application Publication
(10) Pub. No.: US 2018/0285579 A1
(43) Pub. Date: Oct. 4, 2018

(54) METHODS AND SYSTEMS FOR ENFORCING SECURITY SETTINGS FOR PRINTING CONFIDENTIAL DOCUMENTS

(71) Applicant: XEROX CORPORATION, Norwalk, CT (US)

(72) Inventors: Jagadish Thiru Karugavur Viswanathan, Chennai (IN); Senthil Arunachalam, Sivaganga (IN); Pandiarajan Subramanian, Chennai (IN)

(21) Appl. No.: 15/473,714

(22) Filed: Mar. 30, 2017

(51) Int. Cl. G06F 21/60; G06F 3/12; H04N 1/44

(52) U.S. Cl. CPC G06F 21/608; G06F 3/1222; G06F 3/1238; H04N 2201/0094; G06F 3/126; G06F 3/1287; H04N 1/4413

(57) ABSTRACT

Disclosed are methods and printer drivers for printing confidential documents. The method includes receiving a document for printing via an application running on a computing device. Then, it is determined whether received document is a confidential document based on at least one of: pre-defined methods and keywords. Then, the user is enforced to use a secure print mode and further invokes one or more security features, based on the determination. Then, the user is prompted to enter a passcode at the computing device for enforcing the secure print mode for the confidential document. A job request including the selected document and command parameters corresponding to the security features is sent to a multi-function device (MFD). The multi-function device enforces the security features for the received job request and prints the document as a secure print based on the passcode entered by the user at the multi-function device.

### TECHNICAL FIELD

The presently disclosed subject matter relates to the field of printing, and more particularly to methods and systems for printing one or more documents such as confidential documents by enforcing one or more security features.

### BACKGROUND

Printing devices, like printers, multi-function devices, are very common these days and are frequently used by people in their offices and homes. A user may print documents such as confidential documents with critical information at the printing devices. Usually multiple users such as colleagues or family members share the same printing device. Most of the time, the printing device is located far from the user. The user may give a print command using his/her associated computing device such as a phone, a mobile device, a computer, and so forth. Based on the print command, a printer driver of the computing device sends a print job request to the printing device over a wired network, a wireless network, or a combination of these. The printing device prints the document, and then the user collects the printed document from the printing device. If the document is confidential, then there is a risk in printing such documents using shared printing devices as other users may be present at or around the printing device and hence may result in leakage of confidential information.

To overcome the above-mentioned problems, there exists printing devices that allow a user to print confidential documents as secure print. In the secure print, the user needs to enter a password at the printing device and then printing of the document may begin. Though, this is a secure method for printing confidential documents, but suffers from limitations. Even though the document is printed using the passcode, a copy of the document is stored in the device's memory, which may be considered as a security breach. Moreover, the configuration is such that the printer device prints all documents as secure prints irrespective whether documents are confidential or not. And providing the passcode for every document sometimes frustrate the user. Hence, in light of the limitations with existing techniques, there arises a need for improved methods and systems for printing confidential documents.

### SUMMARY

According to aspects illustrated herein, there is provided a method for printing one or more documents in a secure manner. The method includes receiving a document for printing from a user via an application running on a computing device. Then it is determined whether the document is a confidential document based on at least one of: one or more pre-defined methods and a plurality of keywords, the determination is performed by a printer driver of the computing device. Based on the determination of the document as the confidential document, the user is enforced to use a secure print mode and invoke one or more security features. The user is prompted to enter a passcode at the computing device for enforcing the secure print mode for the confidential document. A job request is sent to a multi-function device, the job request includes the confidential document for printing and one or more command parameters corresponding to the one or more security features. The multi-function device enforces the one or more security features for the received job request, the multi-function device prints the confidential document received in the job request as a secure print, based on the passcode entered by the user at the multi-function device.

According to other embodiments illustrated therein, a computing having a printer driver is disclosed. The printer driver is configured to: receive a document for printing from a user via an application running on the computing device; determine whether the received document is a confidential document, based on at least one of: one or more pre-defined methods and a plurality of keywords; enforce the user to use a secure print mode based on the determination of the document as the confidential document; prompt the user to enter a passcode at the computing device; and send a job request including the confidential document for printing and one or more commands corresponding to the one or more security features to a multi-function device. The multi-function device is configured to enforce the one or more security features for the received job request, the multi-function device prints the confidential document received in the job request as a secure print, based on the passcode entered by the user at the multi-function device.

According to embodiments illustrated therein, a system is disclosed. The system includes a computing device and a multi-function in communication with the computing device. The computing device includes a printer driver that is configured: to detect whether a document sent by a user for printing is a confidential document based on: at least one of one or more pre-defined methods and a plurality of keywords; automatically enable a secure print mode and further invoke one or more security features, based on the determination of the document as the confidential document; prompt a user to enter a passcode at the computing device for enforcing the secure print mode for the confidential document; and send a job request including the confidential document for printing and one or more command parameters corresponding to the one or more security features to a multi-function device. The multi-function device includes a transceiving device configured to receive the job request from the printer driver. The multi-function device includes a processor configured to: prompt the user to enter the passcode for printing the confidential document received in the job request; printing the confidential document; removing the confidential document from the multi-function device; and creating an audit log for the job request as received from printer driver.

Other and further aspects and features of the disclosure will be evident from reading the following detailed description of the embodiments, which are intended to illustrate, not limit, the present disclosure

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1A and FIG. 1B are schematic diagrams illustrating exemplary environments where various embodiments of the present disclosure can be practiced.

FIG. 2 is a block diagram illustrating various system elements of an exemplary computing device for enforcing one or more security features for confidential documents.

FIG. 3 is a block diagram illustrating various system elements of an exemplary multi-function device for printing confidential documents.

FIG. 4 is a flowchart illustrating an exemplary method for printing one or more confidential documents.

FIG. 5 is a pictorial representation illustrating steps performed for printing one or more confidential documents.

FIG. 6 is a screen shot depicting a passcode entered by a user at a computing device.

FIGS. 7A-7D are screenshots of user interfaces of a multi-function device.

### DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Definitions

Definitions of one or more terms that will be used in this disclosure are described below without limitations. For a person skilled in the art, it is understood that the definitions are provided just for the sake of clarity, and are intended to include more examples than just provided below.

A “computing device” is an electronic device, which is typically used by a user for daily tasks such as surfing, emails, printing, etc. Examples of the computing device may include, but are not limited to, a smart phone, a desktop computer, a personal computer, a laptop computer, tablet computer, personal digital assistant (PDA) and so forth. In the context of the present disclosure, the computing device includes a print driver configured for identifying documents as confidential documents and for enforcing one or more security features for the confidential documents. The computing device may include software, hardware, firmware, and combination thereof. The computing device may also be referred as a client device.

A “Multi-Function Device” (MFD) is a single device or a combination of multiple devices capable of performing one or more functions such as, but not limited to, scanning, printing, editing of documents, and so forth. The multi-function device may interchangbly be used with the phrase “printer” or a “printing device.” In the context of the present disclosure, the multi-function device prints the confidential documents as secure prints and enforces the security features for the confidential documents.

One or more security features are the features that keep the confidential documents secure. Few such non-limiting examples include Immediate Job Overwrite (IJO), encryption of the confidential document, audit log, hiding an internet protocol (IP) address of the computing device, enforcing the user to use 256-bit encryption, hiding a user name available in the confidential document, and image security.

The term “enforce” is to enable secure mode option and disable other options such as normal print, save job, fax job, when documents are identified documents as confidential documents. And this further includes enable one or more security features for the confidential documents. Secure mode option is an option available for printing documents in a secure manner. This option is enabled by default as soon as the print driver identifies the document as confidential.

The term “confidential documents” includes documents containing critical information, private information, secret information or a combination thereof. The confidential documents may be any type of document such as a MS word document, MS Excel, MS PPT, PDF document or the like.

### Overview

The present disclosure provides methods and systems for printing one or more documents such as confidential documents. The confidential documents include text, images, graphics or a combination thereof. A user sends a document for printing via an application running on a computing device. The computing device includes a printer driver. The printer driver determines whether the document received for printing is a confidential document and based on the detection, the printer driver enforces a user to use a secure print mode. Further, the printer driver enforces one or more security features through the printer driver to a multi-function, for the confidential document. Few non-limiting examples include immediate job overwrite (IJO), audit log, and so forth. The security features are enforced through the multi-function device.

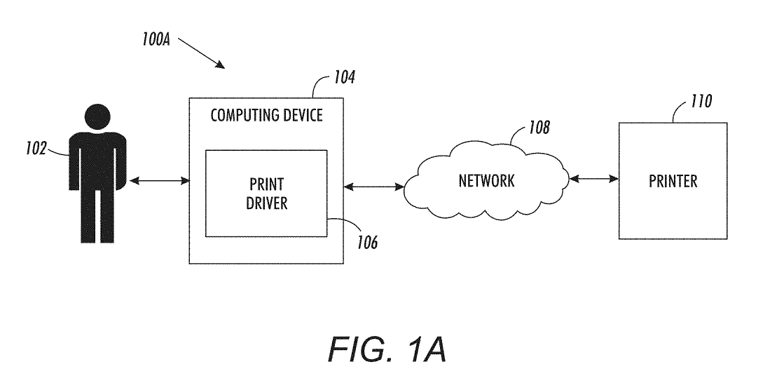

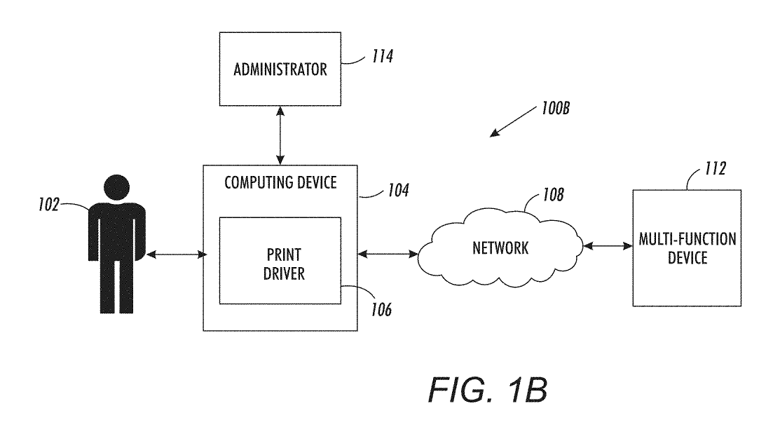

FIG. 1A is a schematic diagram illustrating an exemplary environment 100A in which various embodiments of the disclosure may be practiced. As shown, the environment 100A includes a computing device 104 and a printer 110 communicatively coupled to the computing device 104 over a network 108. Examples of the computing device 104 may include, but are not limited to, a personal computer, a laptop, a tablet computer, a smart phone, a mobile phone, and so forth. The network 108 may include multiple networks or sub networks, each of which may include, for example, a wired or wireless data pathway. The network 108 may include, but not limited to, a personal area network (PAN), a local area network (LAN), a Bluetooth® network, a storage area network (SAN), a home area network (HAN), the Internet®, a campus area network (CAN), a wide area network (WAN), a metropolitan area network (MAN), a virtual private network (VPN), an enterprise private network (EPN), Internet, a global area network (GAN), and so forth. The network 108 may include a circuit-switched voice network, a packet-switched data network, or any other network able to carry electronic communications. For example, the network 108 may include networks based on the Internet protocol (IP) or asynchronous transfer mode (ATM), and may support voice using, for example, VoIP, Voice-over-ATM, or other comparable protocols used for voice data communications. In one example, the network 108 may include a cellular telephone network configured to enable exchange of text or SMS messages. The network 108 may either be a dedicated network or a shared network, which represents an association of the different types of networks that use a variety of protocols. In addition, the network 108 may include network devices, such as network switches, hubs, routers, HBAs, for providing a communication link between the printer 110 and other connected devices/systems.

As shown, a user 102 uses the computing device 104 for day-to-day tasks such as emails, social networking, printing, chatting, surfing, etc. An application runs on the computing device 104 and the user 102 gives a print command for printing one or more documents. Various examples of the application include, but not limited to, MS word, MS Excel, MS PPT, PDF, or the like. The one or more documents are confidential documents such as company documents, client documents, personal documents or a combination thereof. The documents may include text, images, graphics or a combination thereof.

The computing device 104 includes a printer driver 106. The printer driver 106 may be implemented or installed in any suitable operating system running on the computing device 104 such as, but are not limited to, Windows, Unix, Linux, and so forth. As mentioned, the user 102 gives the print command via the application and the print command is received by the printer driver 106 of the computing device 104. The printer driver 106 manages one or more print commands as submitted from the user 102 of the computing device 104. Here, the user 102 submits a document for printing. The printer driver 106 receives the document.

The printer driver 106 is configured to determine whether the received document is a confidential document based on at least one of one or more pre-defined methods and a number of keywords. The pre-defined methods may include, but are not limited to, identifying a “confidential” watermark in the document, determining if the document is set as “confidential” using MS word settings, and so forth. Other than this, the document may be identified as confidential based on the keywords such as, but are not limited to, confidential, critical, important, private, secret, top secret, and so forth. The keywords may be inside the document or these keywords may be in the file name of the document. When the document is detected as a confidential document, the printer driver 106 enables “Secure Print” mode and disable other job types for example, normal print, saved job, sample print, and so forth. Meaning that the user 102 may not be able to give print as normal job once the document is detected as the confidential document. The printer driver 106 invokes one or more security features based on the determination of the document as the confidential document. Examples of the security features may include, but are not limited to, an immediate job overwrite (IJO), encryption of the document, audit log, hiding an internet protocol (IP) address of the computing device 104, enforcing the user to use 256-bit encryption, hiding a user name available in the document, image security by encrypting the images present in the document, and so forth. The printer driver 106 prompts a user to enter a passcode at the computing device for enforcing the secure print mode for the confidential document. The user enters the passcode and the printer driver 106 receives the passcode entered by the user 102. The passcode may include one or more characters, numerals, special characters or a combination thereof. The passcode may be of any length.

The printer driver 106 creates a job request including the confidential document, the passcode and one or more command parameters corresponding to the security features. For example, if the security feature is immediate job overwrite (IJO), the command parameter may be overwrite. If the security feature is encryption of the document, the command parameter may be encryption. If the security feature is audit log, the command parameter may be audit. If the security feature is hiding an internet protocol (IP) address of the computing device 104, the command parameter may be hide IP. If the security feature is enforcing the user to use 256-bit encryption, the command parameter may be 256 bit encryption. If the security feature is hiding a user name available in the document, the command parameter may be hide use name. If the security feature is image security by encrypting the images present in the document, the command parameter may be encrypting image. The print driver is configured to enforce all of the security features, one the security features, some of these security features or the like. The printer driver 106 then sends a job request to the printer 110 as connected over the network 108.

Further, the printer 110 receives the job request including the confidential document, the passcode and one or more command parameters. The printer 110 stores the received job request in a memory of the printer 110. The printer 110 identifies the one or more command parameters received in the job request from the printer driver 106. The printer 110 enforces the corresponding one or more security features for the received job request. For example, if the printer 110 receives IJO and audit as command parameter, the printer 110 enforces the IJO and audit for the received confidential document. The IJO may include pausing an execution of another job request currently being executed at the printer 110, executing the received job request before the another job request, removing the document corresponding to the job request post execution of the job request from the printer 110. The audit log may enable detailed information about the job request submitted by the user, the detailed information may further be traced by other user such as the administrator of the computing device 104 or the printer 110.

Before enforcing the security features, the printer 110 prints the confidential document as a secure print. Here, the printer 110 prompts the user 102 to input the passcode as input at the computing device 104. If the passcode input at the printer 110 matches with the passcode input at the computing device 104, then the printer 110 prints the confidential document. The printer 110 removes from the printer 110 as soon as the printing of the document or the processing of the job request is completed at the printer 110. In this manner, the disclosures keeps confidential document secure.

As seen in FIG. 1B, an administrator 114 configures the printer driver 106 to identify the document as confidential document. For example, the administrator 114 while installing the printer driver 106 at the computing device 202 may provide the keywords to identify the confidential document. The administrator 114 associated with the computing device 104 configures the printer 106 to enforce one or more security features.

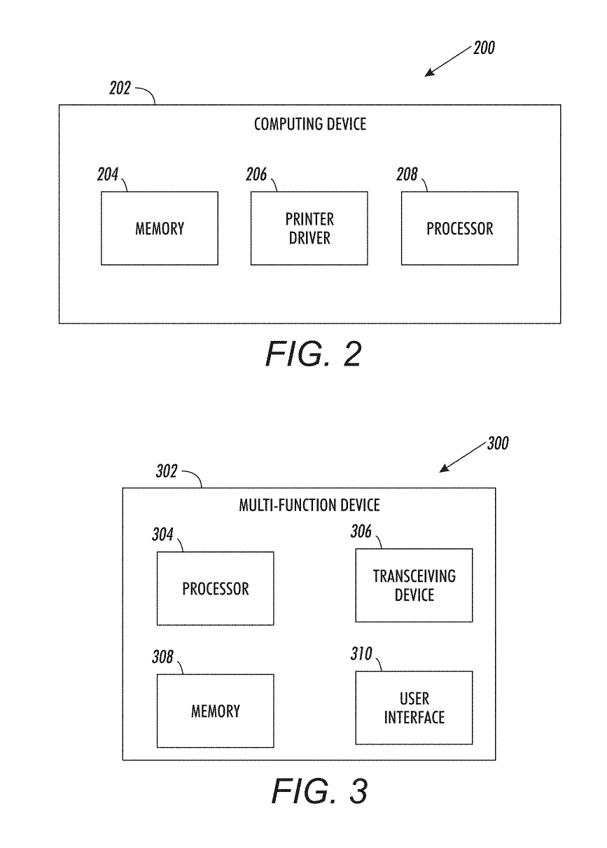

FIG. 2 is a block diagram 200 illustrating various system elements of an exemplary computing device 202. As shown, the computing device 202 includes a printer driver 206, a memory 204, and a processor 208. Each of the elements 204, 206 and 208 is connected to each other via a bus or a communication protocol and accordingly communicates with each other. The memory 204 stores one or more instructions executable by the processor 208. The instructions may include instructions for determining whether a document received for printing is a confidential document, and so forth.

The printer driver 206 may be a software, hardware, or combination thereof. The printer driver 206 may be a single device or a combination of multiple devices or software applications. Further, the printer driver 206 receive one or more requests for printing documents based on a number of print commands from a user such as the user 102. In context of the current disclosure, the printer driver 206 is configured to detect whether a document is a confidential document or includes confidential information. The printer driver 206 determines the confidential document based on at least one of: one of one or more pre-defined methods and a number of keywords. The printer driver 206 enforces one or more security features via the print driver to a multi-function device, a printer or equivalent device connected over a network. The printer driver 206 further creates a job request and send the job request to a multi-function device for further processing. More details on the printer driver 206 are discussed above in FIG. 1 and thus, can be referred to.

FIG. 3 is a block diagram 300 illustrating various system elements of an exemplary multi-function device 302. The multi-function device 302 is in communication with the printer driver 206 of the computing device 202 as discussed with reference to FIG. 2. The multi-function device 302 performs one or more functions such as, but not limited to, scanning, printing, imaging, and so forth. Further, the multi-function device 302 may include software, hardware, firmware, and combination thereof. As shown, the multi-function device 302 includes a processor 304, a transceiving device 306, a user interface 310, and a memory 308. Each of the elements 304, 306, 308, and 310 is connected to each other via a bus or a communication protocol and accordingly communicates with each other.

The transceiving device 306 is configured to receive one or more job requests from the computing device, such as the computing device 104 via the network 108. The job request may include a confidential document for printing and one or more command parameters corresponding to one or more security features.

The memory 308 stores one or more instructions executable by the processor 304 and job requests as received from the computing device 202. The memory 308 may further store one or more user identifiers, job identifiers, and so forth. The one or more user identifiers may be associated with a number of users such as the user 102. The details may be stored in any desired format. The user interface 310 may be a graphical user interface (GUI) allowing the user 102 to access the multi-function device for printing, copying, faxing or imaging.

The processor 304 executes instructions for printing, scanning, copying, imaging and so forth.

The processor 304 is configured to execute one or more instructions for enforcing one or more security features based on one or more command parameters. The processor 304 is configured to execute one or more job requests received from the computing device 104 as discussed with reference to FIG. 1B. The processor 304 is configured to prompt the user 102 to enter the passcode for printing the document received in the job request. The user enters the passcode at the user interface 310 of the multi-function device 302. The multi-function device 302 prints the confidential document. The processor 304 is configured to enforce the one or more security features corresponding to the one or more command parameters for the received job request. The processor 304 enforces the IJO for the job request, i.e., removes the selected document, i.e., the document including the confidential information received in the job request from the multi-function device 302 as soon printing of the document is over. The processor 304 enforces or enables an audit log based on the received one or more command parameters for the received job request. The detailed information includes, but not limited to, a time of printing, an IP address of the computing device, a user identifier, and so forth, for the job request.

In some embodiments, the processor 304 may be configured to authenticate an identity of the user 102 based on a passcode. In some embodiments, the processor 304 may authenticate an identity of the computing device 104 and/or the user 102 based on the passcode. Examples of the passcode may include a password, a user identifier, an employee identifier, a computing device identifier, a document identifier, a biometric identifier or input, and so forth.

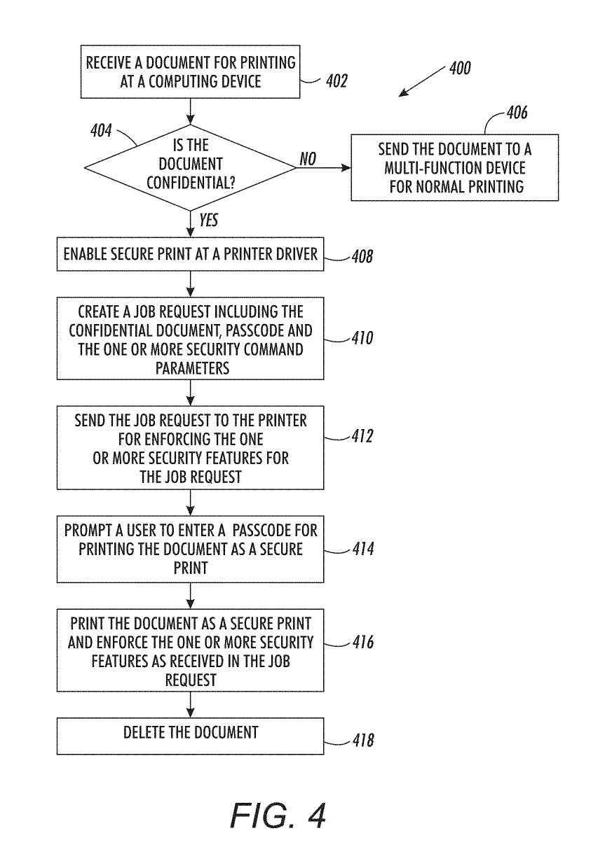

FIG. 4 is a flowchart illustrating an exemplary method 400 for printing a confidential document. As discussed with reference to FIG. 1A, the user 102 can give one or more print commands at the computing device 104. The print commands are accepted by the printer driver 206 installed on the computing device 104 (or a client device), which in turn may be processed by a multi-function device or printer.

At 402, a document is received by a printer driver of a computing device, for printing. The document is submitted by a user via an application running on the computing device. The document is considered as a confidential document. The document may be document marked as a confidential document or a document including confidential information.

At 404, it is checked whether the received document is a confidential document. The confidentiality of the document is determined based on one or more pre-defined methods and/or predefined keywords. The pre-defined methods may include, but are not limited to, identifying a “Confidential” watermark in the document, determining if the document has been set as “Confidential” using MS word settings, and so forth. The keywords may include, but are not limited to, confidential, critical, important, private, a logo image, secret, top secret and so forth. If no, then at 406, the document is sent to the printer 110 for normal printing. The printer 110 prints the document received in the job request as a normal print.

If yes, then 408 is executed. At 408, secure print mode is enabled (or enforced) at the printer driver 106. The user 102 is prompted at the computing device 104 to use only secure print for the confidential document and further is prompted to enter a passcode at the computing device 104.

Then at 410, a job request is created by the printer driver 106. The job request includes the confidential document for printing, the passcode and one or more security command parameters corresponding to one or more security features.

Then at 412, the printer driver 206 sends the job request to the printer 110 for enforcing one or more security features for the job request. Examples of the security features are discussed above in detail.

Further at 414, the user 102 is prompted to enter a passcode for printing the document as a secure print. The user 102 is prompted at the printer 110 for entering the passcode. Examples of the passcode may include a password, a user identifier, an employee identifier, a computing device identifier, a document identifier, a biometric identifier or input, and so forth.

Then at 416, the confidential document is printed as a secure print and enforces the security features based on the one or more command parameters received in the job request. Thereafter at 418, the document is deleted from the printer 110.

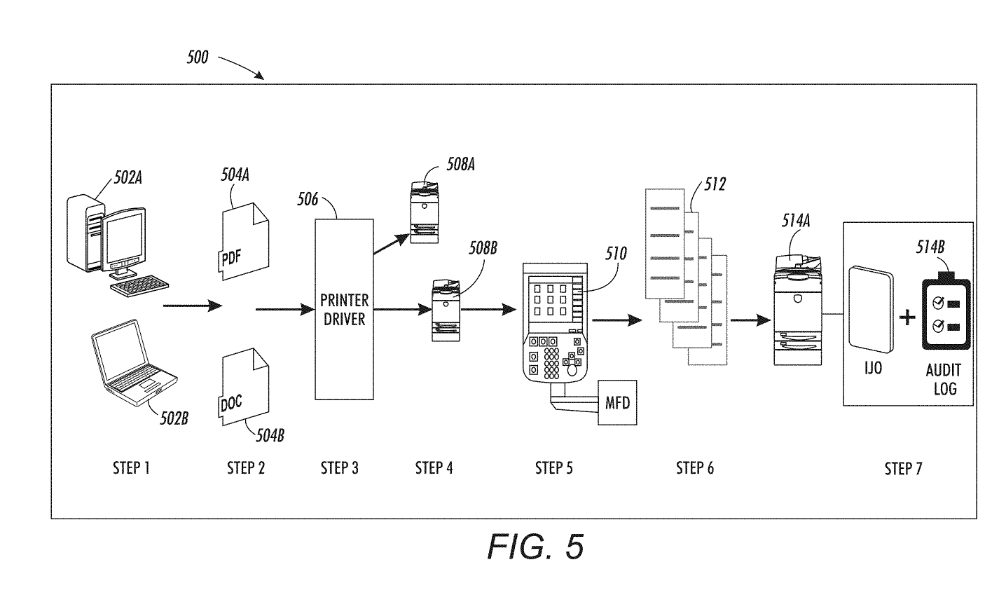

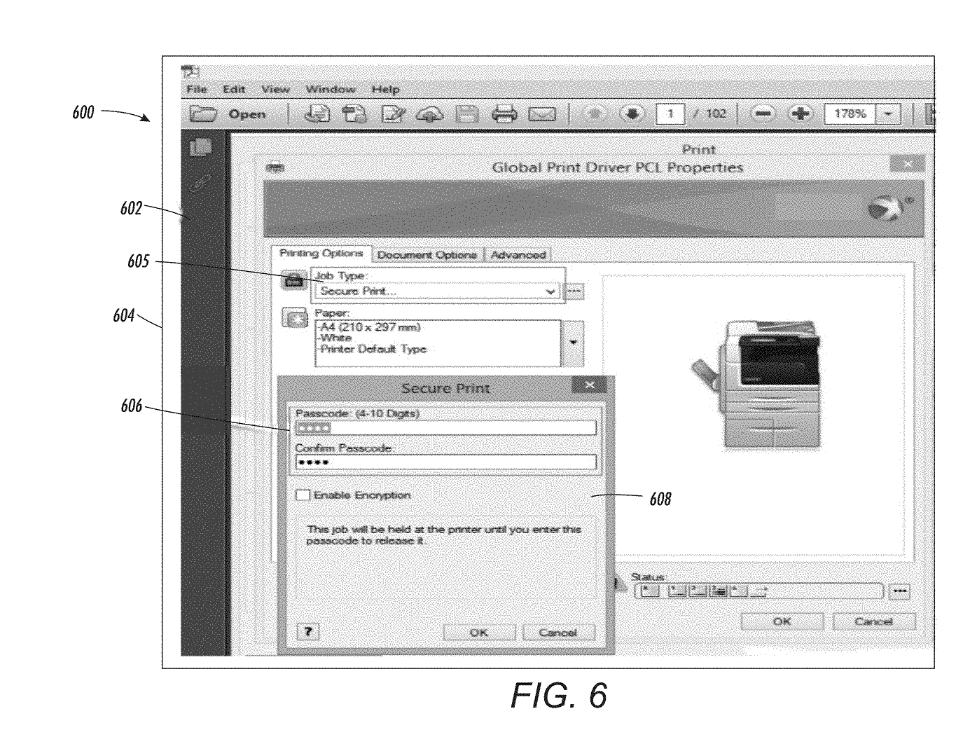

FIG. 5 is a pictorial representation 500 illustrating steps performed for printing one or more confidential. In the shown representation, the user uses computing devices such as a computer 502A, and a laptop computer 502B. At the device 502A and 502B, a user selects a document for printing and sends a print command from the personal computer 502A and the laptop computer 502B for printing (shown as “Step 1”). The document may be of any suitable format such as, but not limited to a PDF format, a MS-word document format, and so forth. As shown, at the personal computer device 502A, the user selects a PDF document marked as 504A. Similarly, at the laptop device 502B, the user selects a document such as MS-word document 604B for printing. At “Step 2,” a printer driver 506 is invoked for managing printing commands.

Then at “Step 3,” the printer driver 506 identifies whether the documents 504A and 504B received for printing are confidential. Based on the identification, the driver 506 provides the user to use only a “Secure Print” setting for printing the same. When the user submits a job request including the confidential documents 504A and 504B through the printer driver 506 in a “Secure Print” mode, then the job request may include one or more command parameters. In the “Secure Print” mode, the user is asked to enter a passcode. Then, the printer driver 506 may send the job request including the confidential documents 504A and 504B and the one or more command parameters to one or more devices such as multi-function device 508A and a multi-function device 508B.

Then at “Step 4,” the job request including the confidential documents 504A and 504B and the one or more command parameters may be received at the at least one of the printer 508A and the multi-function device 508B. At one of: the printer 508A and the multi-function device 508B, one or more security features or options may be enabled based on the one or more command parameters.

As the confidential document are to be printed in the “Secure Print” mode, therefore at “Step 5,” each of the printer 508A and the multi-function device 508B may release the job request only by using a secure passcode. In some embodiments, the user may be prompted to enter the passcode at a user interface 510 of the at least one of the devices 508A and 508B. Then at “Step 6,” the documents 504A and 504B may be printed (shown as 512 printed documents) and the job request is completed.

Thereafter at “Step 7,” the one or more security features may be implemented such as, an Immediate Job Overwrite 514A may remove the source document (i.e., the documents 504A-504B), from the at least one of the printer 508A and the multi-function device 508B, as soon the printing according to the job request completes. Further, an Audit Log 514B may be enabled with the detailed information about the job request submitted by the user.

FIG. 6 is a screen shot 600 of a user interface 602 of a computing device 604. The computing device 604 include a printer drivers (such as the printer driver 106 of FIG. 1A) configured to determine whether a document received for printing is a confidential document or not. When the printer driver determines that a document received for printing as confidential then the user interface 602 is displayed on the computing device. In the user interface 602, the printer driver enforces a “Secure Print” marked as 605, for a job including the confidential document for printing. Further, the printer driver prompts a user of the computing device to enter a passcode at a passcode input interface 608 on the user interface 602. The job including the confidential document then is submitted or sent to a multi-function device for printing.

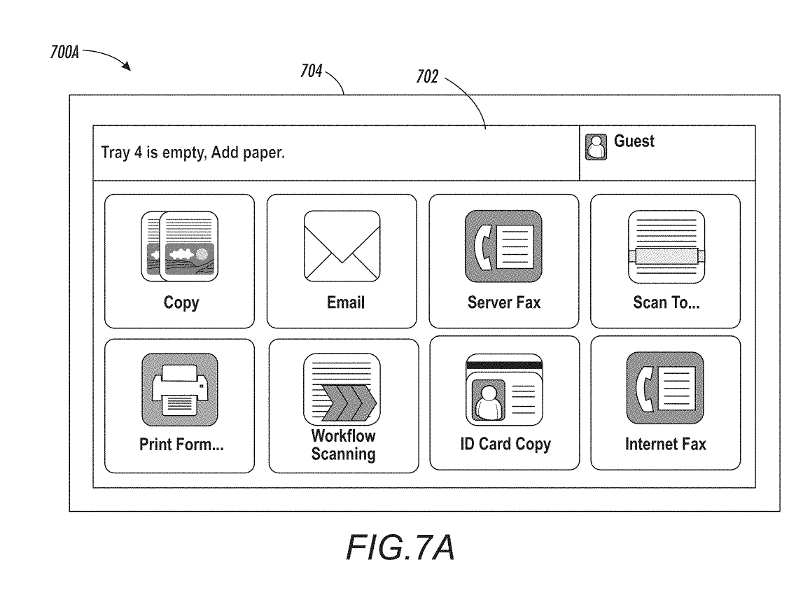

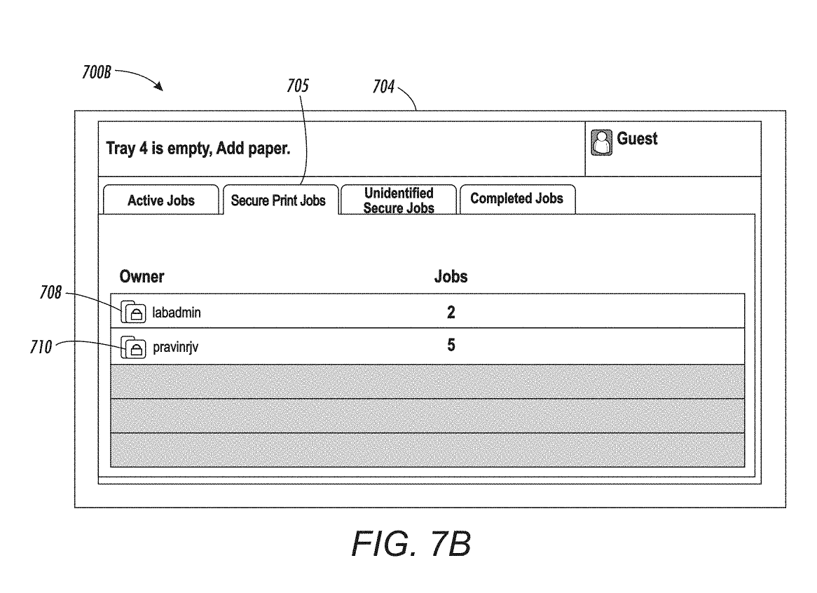

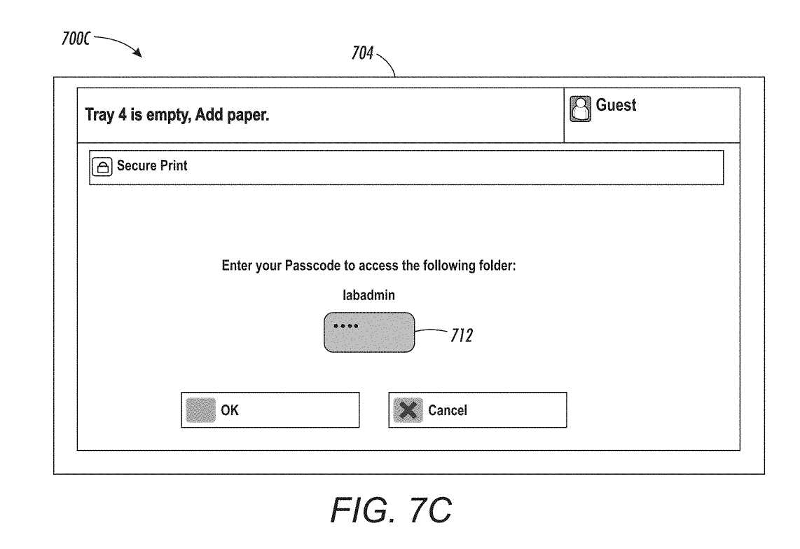

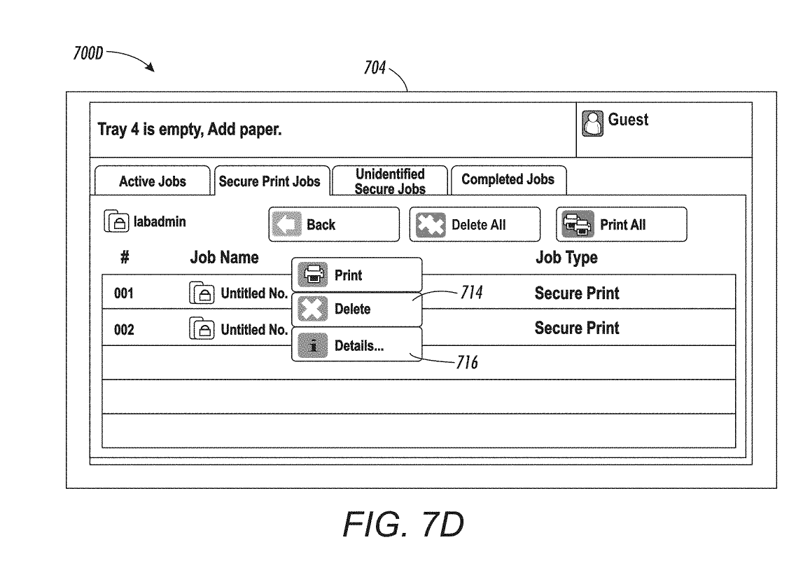

FIGS. 7A-7D are screenshots of user interfaces of a multi-function device 704. A screen shot 700A of a home screen interface 702 on the multi-function device 704 is shown in FIG. 7A. Another screenshot 700B of a user interface 706 is shown that allows a user to select a tab “secure print jobs” tab from the user interface 706. The user interface 706 shows one or more secure print jobs as 708 and 710. In the next snapshot 700C, the user is prompted by the multi-function device 704 to enter a valid secure print password marked as 712. The secure print password is same as the passcode entered by the user at the printer driver of the computing device 604 as shown in FIG. 6.

In the snapshot 700D of FIG. 7D, security options such as Delete 714, Details 716 are enabled by the multi-function device 704. The user can select any of these options and perform the needed action. For example, if the user selects the option 714, the multi-function device 704 deletes the confidential document from the multi-function device. In another example, if the user selects the option 716, the multi-function device 704 provides more details on the job request.

The presently disclosed methods and systems enable a user to print confidential documents in a secure manner without any leakage of information in nearby environment. Specifically, the methods and systems print confidential documents and enforce security options for the confidential documents. In this manner, the confidential documents are kept secure.

For a person skilled in the art, it is understood that the use of phrase(s) “is,” “are,” “may,” “can,” “could,” “will,” “should” or the like is for understanding various embodiments of the present disclosure and the phrases do not limit the disclosure or its implementation in any manner.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above described system and/or the apparatus and/or any electronic device (not shown).

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “generating” or “monitoring” or “displaying” or “tracking” or “identifying” “or receiving” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for printing one or more documents in a secure manner, comprising:
receiving a document for printing from a user via an application running on a computing device;
determining whether the document is a confidential document based on at least one of: one or more pre-defined methods and a plurality of keywords, the determination is performed by a printer driver of the computing device;
enforcing the user to use a secure print mode and further invoking one or more security features based on the determination of the document as the confidential document, wherein the one or more security features comprise encryption of the confidential document, hiding an internet protocol (IP) address of the computing device, enforcing the user to use 256-bit encryption, hiding a user name available in the confidential document, and image security;
prompting the user to enter a passcode at the computing device for enforcing the secure print mode for the confidential document; and
sending a job request to a multi-function device, the job request comprising the confidential document for printing and one or more command parameters corresponding to the one or more security features,
wherein the multi-function device enforces the one or more security features for the received job request, the multi-function device prints the confidential document received in the job request as a secure print, based on the passcode entered by the user at the multi-function device.

2. The method of claim 1 further comprising receiving the passcode at the printer driver, when the received document is determined as the confidential document.

3. The method of claim 2, further comprising creating the job request including the confidential document and the one or more command parameters.

4. The method of claim 1 further comprising prompting, by the multi-function device, the user to enter the passcode at the multi-function device for releasing the confidential document.

5. The method of claim 1, wherein the one or more security features further comprise an Immediate Job Overwrite (IJO) and audit log.

6. The method of claim 5, wherein the Immediate Job Overwrite (IJO) comprises:
pausing an execution of another job request currently being executed at the multi-function device;
executing the received job request before the another job request; and
removing the confidential document corresponding to the job request post execution of the job request from the multi-function device.

7. The method of claim 1 further comprising creating an audit log for the job request, the audit log includes detailed information about the job request.

8. The method of claim 1 further comprising disabling other print options when the document is determined as the confidential document.

9. The method of claim 1, wherein the enforcing comprise automatically enabling the secure print mode when the document is determined as the confidential document.

10. A computing device, comprising:
a printer driver configured to:
receive a document for printing from a user via an application running on the computing device;
determine whether the received document is a confidential document, based on at least one of: one or more pre-defined methods and a plurality of keywords;
enforce the user to use a secure print mode based on the determination of the document as the confidential document;
prompt the user to enter a passcode at the computing device; and
send a job request including the confidential document for printing and one or more commands corresponding to the one or more security features to a multi-function device, wherein the one or more security features comprise encryption of the confidential document, hiding an internet protocol (IP) address of the computing device, enforcing the user to use 256-bit encryption, hiding a user name available in the confidential document, and image security,
wherein the multi-function device is configured to enforce the one or more security features for the received job request, the multi-function device prints the confidential document received in the job request as a secure print, based on the passcode entered by the user at the multi-function device.

11. The computing device of claim 10, wherein the printer driver is further configured to receive the passcode when the received document is determined as the confidential document.

12. The computing device of claim 10, wherein the printer driver is further configured to create the job request including the confidential document to be printed and one or more command parameters.

13. The computing device of claim 10, wherein the one or more security features further comprise an Immediate Job Overwrite (IJO) and audit log.

14. The computing device of claim 10, wherein the multi-function device is configured to enforce the Immediate Job Overwrite (IJO) by:
pausing an execution of another job request currently being executed at the multi-function device;
executing the received job request before the another job request; and
removing the document corresponding to the received job request post execution of the job request from the multi-function device.

15. The computing device of claim 10, wherein the one or more security features are configured in the printer driver of the computing device.

16. The computing device of claim 10, wherein the multi-function device is configured to create an audit log for the job request.

17. The computing device of claim 10, wherein the printer driver automatically enables a secure print mode for document.

18. A system comprising:
a computing device comprising a printer driver configured to:
detect whether a document sent by a user for printing is a confidential document based on: at least one of one or more pre-defined methods and a plurality of keywords;
automatically enable a secure print mode and further invoke one or more security features, based on the determination of the document as the confidential document;
prompt a user to enter a passcode at the computing device for enforcing the secure print mode for the confidential document; and
send a job request including the confidential document for printing and one or more command parameters corresponding to the one or more security features to a multi-function device, wherein the one or more security features comprise encryption of the confidential document, hiding an internet protocol (IP) address of the computing device, enforcing the user to use 256-bit encryption, hiding a user name available in the confidential document, and image security; and
the multi-function device in communication with the printer driver of the computing device, comprising:
a transceiving device configured to receive the job request from the printer driver; and
a processor configured to:
prompt the user to enter the passcode for printing the confidential document received in the job request;
printing the confidential document;
removing the confidential document from the multi-function device; and
creating an audit log for the job request as received from printer driver.

19. The system of claim 18, wherein the one or more security features further comprise an Immediate Job Overwrite (IJO) and audit log.

20. The system of claim 18, wherein the processor is configured to match the passcode received at the multi-function device with the passcode receive at the computing device.
